(19) United States
(12) Patent Application Publication
(10) Pub. No.: US 2019/0234462 A1
(43) Pub. Date: Aug. 1, 2019

(54) CHABOT TRUE-AXIS BEARING

(71) Applicant: John Stephen Chabot, Mishawaka, IN (US)

(72) Inventor: John Stephen Chabot, Mishawaka, IN (US)

(21) Appl. No.: 16/114,109

(22) Filed: Aug. 27, 2018

Related U.S. Application Data
(60) Provisional application No. 62/551,209, filed on Aug. 28, 2017.

(51) Int. Cl. F16C 33/32; F16C 19/06

(52) U.S. Cl. CPC F16C 33/32; F16C 2202/08; F16C 19/06

(57) ABSTRACT

The Chabot True-Axis Bearing makes use of a naturally occurring circle. The heart of the invention is that this naturally occurring circle results from the path of least resistance given by the constant formation of malleable races. The dynamic nature of the bearing races produces a level of precision that fully exploits the grade of precision that is in the ball bearings. If the diameters of the ball bearings are within 0.000010 inches of one another, the concentricity of rotation of the host device will be within 0.000010 inches. This level of accuracy of concentric rotation is maintained throughout the life of the host device.

### BACKGROUND OF THE INVENTION

Spindle to base devices abound whose purpose is to transfer the radial force from the rotating spindle to a base while minimizing friction. This invention is a unique addition to that large group. More specifically the invention is very well suited for those devices requiring a high degree of accuracy both radially and axially.

### BRIEF SUMMARY OF THE INVENTION

The invention is a dynamic device which takes advantage of the concept that a thing will follow the path of least resistance. In this invention the path of least resistance is coincident with radial trueness and is also coincident with functionally near perfect axial immobility. The invention exploits to theoretical perfection, the spherical accuracy and the uniformity in size of the ball bearings by the way in which they are arranged in this invention.

The radial trueness and the axial immobility make the invention useful for many tasks including but not limited to the inspection of round specimens, the fabricating of round details in machining applications, and even the rotation of cutters or abrasive tools. The invention is useful wherever a rotational movement is necessary but especially where radial precision is required.

Applications of the invention will not suffer the loss of accuracy due to normal use that is common in other ball bearing devices. The structure of the invention provides a condition wherein the device is continually wearing in to a more perfectly concentric rotation as well as a state of continually increasing durability.

### BRIEF DESCRIPTION OF THE DRAWINGS

FIG. 1-1 depicts an X-ray top view of a typical application of the invention. FIG. 1-2 is a section view of FIG. 1-1 coincident with the axis of rotation. In these two drawing views the components may be viewed from the top and center planes.

FIG. 2 is an exploded view of the device in FIG. 1-1 and FIG. 1-2. In this view can be seen ITEM 1 which is the base receiving the radial load and ITEM 2 which is a flanged spindle. The flange is one of the two parallel surfaces gradually drawn together.

ITEM 5, ITEM 6, and ITEM 1 are shown out of axial position in this exploded view, so that the clarity of the other components and how these fit together can be seen. In assembly, all of the components are on a single axis.

ITEM 3 is one of two rotating races. It is bonded to ITEM 2 and rotates with it. ITEM 3 has a planar surface generated on it with a groove machined into this planar surface thus producing two circular vertices upon which, ITEM 4, the array of ball bearings will initially make line contact.

ITEM 4 is an array of ball bearings sufficient to fill the entire groove. The array is two in number. ITEM 5, is a ball bearing spacer whose function is to keep the individual ball bearings from bunching and to keep the individual ball bearings from rubbing against one another, thereby preserving their accuracy.

ITEM 6 depicts the two fixed races. These can be two details but in this particular design the two fixed races are generated, one in each end, in a single detail. ITEM 6 has the same planar surface with a groove machined into it as ITEM 3. Said surface and groove are on both ends because in this instance ITEM 6 is effectively two components in one.

ITEM 6 is bonded to ITEM 1, the base and remains immobile with it.

ITEM 7 is the other rotating race and as such is the counterpart to ITEM 3 with the addition of a long neck. This additional length has a close fitting inside diameter meant to slide precisely along the path defined by the axis of rotation of the spindle.

ITEM 8 is a tension nut and as such provides the source of pressure that gradually draws the races closer together. It does this by advancing along a fine pitch thread that is machined onto the end of ITEM 2.

ITEM 9 is a combination crank arm and a base for a band spring, ITEM 11. This crank arm transfers the tension from the band spring, ITEM 11, to the tension nut, ITEM 8. ITEM 9 is bonded to ITEM 8 and moves with it.

ITEM 10 is a band spring anvil, and its purpose is to provide a pressure point against which one end of the band spring, ITEM 11, can apply spring pressure.

ITEM 11 is a band spring whose function is to apply constant rotational pressure to the tension nut, ITEM 8.

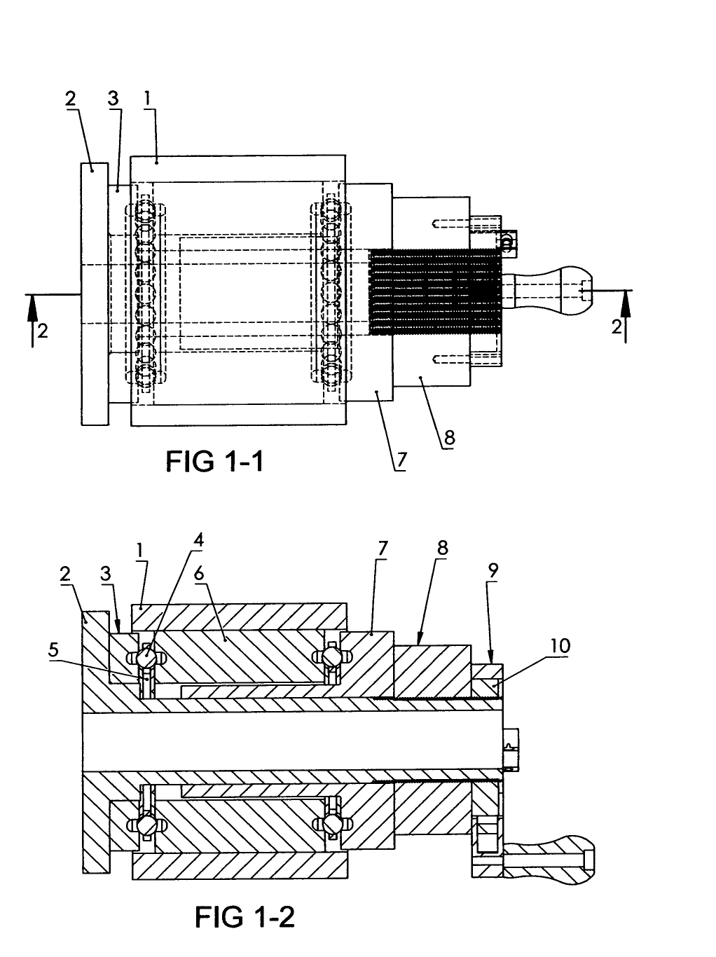

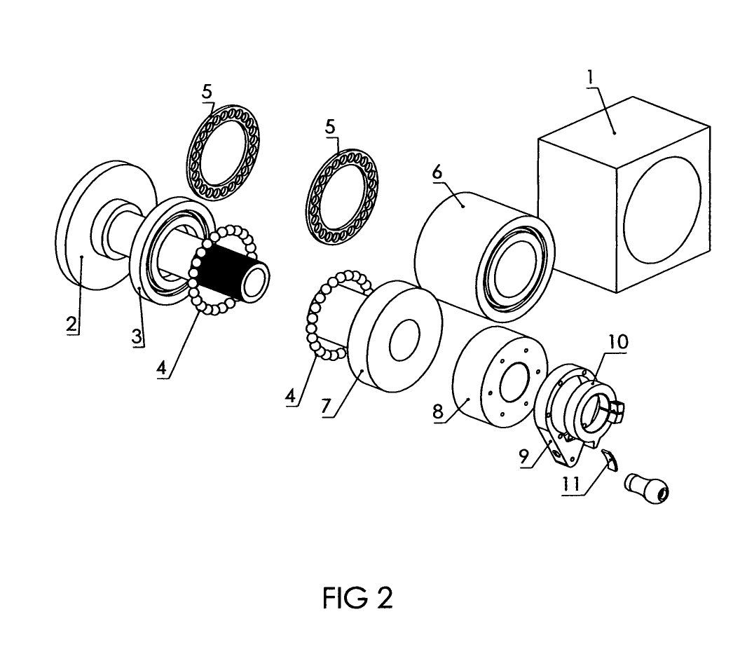

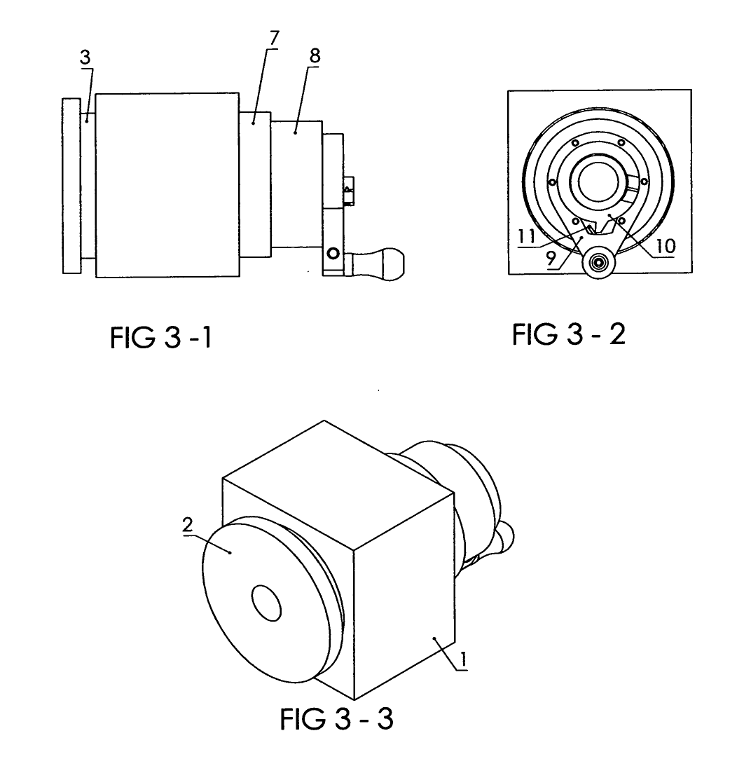

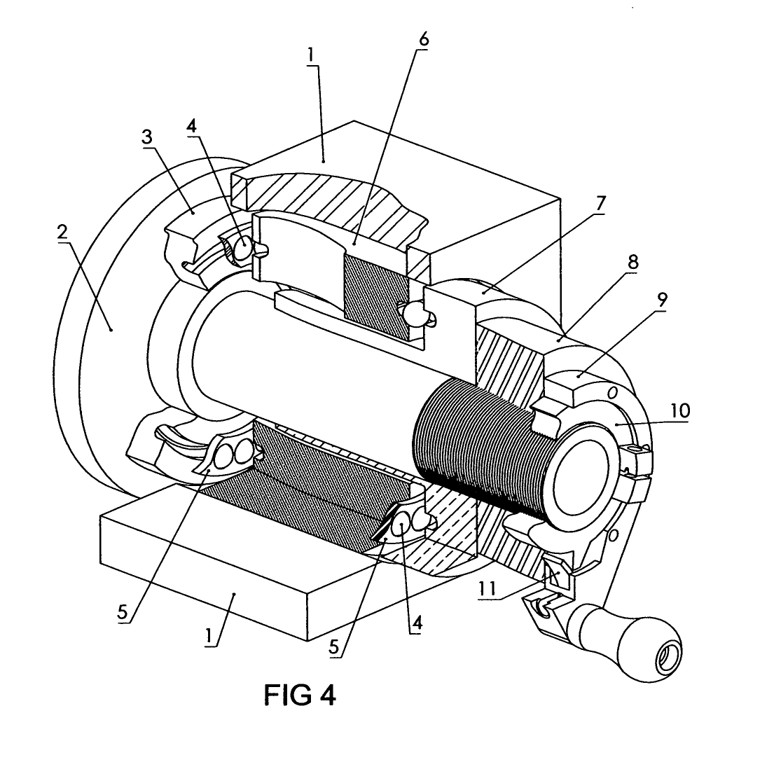

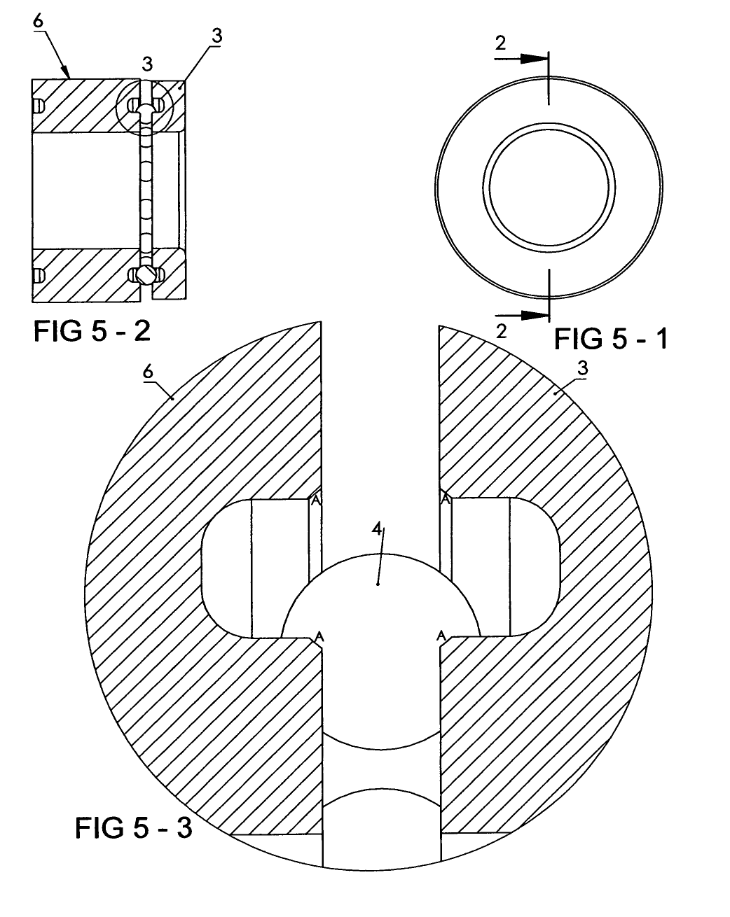

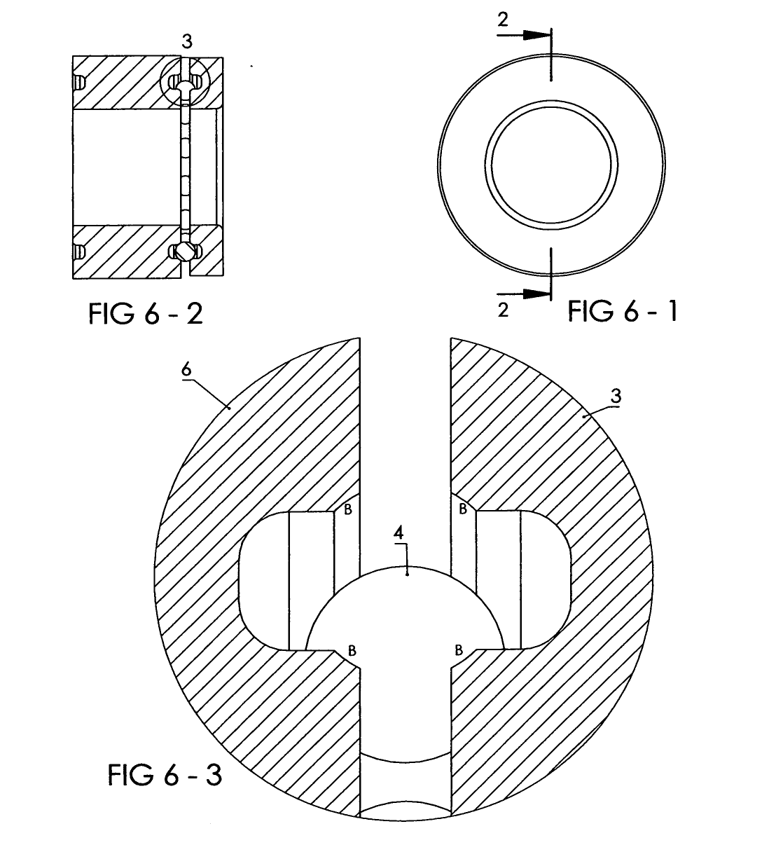

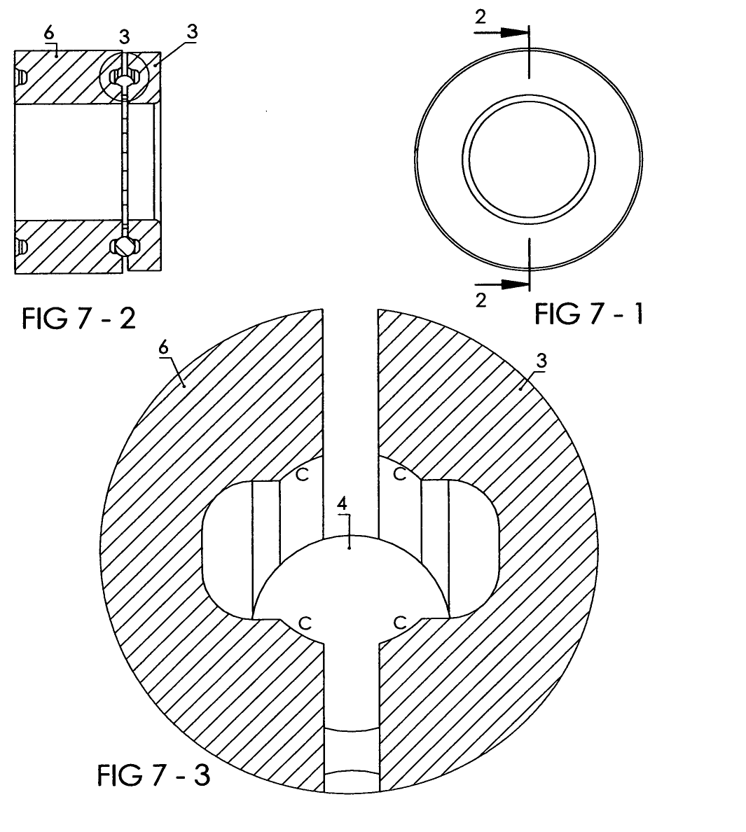

FIG. 3-1, FIG. 3-2, and FIG. 3-3 are drawings depicting several views of an assembled fixture utilizing the invention. These drawing highlights some of the possible uses of the invention. Shown therein are a faceplate, part of ITEM 2, on the front end ready to receive a fixture or tool. On the back end is shown a crank arm ready to receive a handle or even with a few added components to be motor powered. FIG. 3-1 is a front view. FIG. 3-2 is a back view. FIG. 3-3 is an isometric view. These three views serve to illustrate some of the exterior components that the interior workings of the invention serve.

FIG. 4 is a cutaway view showing an application of the invention in the assembled condition. The components already mentioned are seen in their working relation to the other components.

FIG. 5-1, FIG. 5-2, FIG. 5-3, FIG. 6-1, FIG. 6-2, FIG. 6-3, and FIG. 7-1, FIG. 7-2, and FIG. 7-3 are drawings whose purpose is to clearly depict what is at the heart of the invention, the malleable races that are constantly being formed by the arrays of ball bearings.

FIG. 5-1 serves to show the location of the section view FIG. 5-2. The section view is generated through the entire assembled fixture from the top surface in a downward direction coincident with the axis of rotation. FIG. 5-2 depicts the fixture thus sectioned viewed from the side. FIG. 5-2 contains a circle drawn upon a specific area of the array of ball bearings where these are in contact with the two malleable races. This circle defines the boundaries of FIG. 5-3 which is a greatly enlarged duplication of the area circled in FIG. 5-2. FIG. 5-3 illustrates clearly the malleable action of the array of spheres under pressure wherein these spheres produce the four arc shaped surfaces labeled with the letter “A”. FIG. 5-3 depicts a small arc typical of the early life of the invention when it has had little usage.

FIG. 6-1 serves to show the location of the section view FIG. 6-2. The section view is generated through the entire assembled fixture from the top surface in a downward direction coincident with the axis of rotation. FIG. 6-2 depicts the fixture thus sectioned viewed from the side. FIG. 6-2 contains a circle drawn upon a specific area of the array of ball bearings where these are in contact with the two malleable races. This circle defines the boundaries of FIG. 6-3 which is a greatly enlarged duplication of the area circled in FIG. 6-2. FIG. 6-3 illustrates clearly the malleable action of the array of spheres under pressure wherein these spheres produce the four arc shaped surfaces labeled with the letter “B”. FIG. 6-3 depicts a medium sized arc typical of the invention after moderate usage.

FIG. 7-1 serves to show the location of the section view FIG. 7-2. The section view is generated through the entire assembled fixture from the top surface in a downward direction coincident with the axis of rotation. FIG. 7-2 depicts the fixture thus sectioned viewed from the side. FIG. 7-2 contains a circle drawn upon a specific area of the array of ball bearings where these are in contact with the two malleable races. This circle defines the boundaries of FIG. 7-3 which is a greatly enlarged duplication of the area circled in FIG. 7-2. FIG. 7-3 illustrates clearly the malleable action of the array of spheres under pressure wherein these spheres produce the four arc shaped surfaces labeled with the letter “C”. FIG. 7-3 depicts a large sized arc typical of the invention after heavy usage.

### DETAILED DESCRIPTION OF THE INVENTION

The invention consists of not less than four planar surfaces generated on a malleable material and arranged in parallel. Referring to FIG. 1-2, FIG. 2, and FIG. 4, one surface on ITEM 3, two surfaces on ITEM 6, and one surface on ITEM 7 can be seen. The surfaces thus referenced in the drawings are those surfaces adjoining the ball bearings (ITEM 4). These four parallel surfaces are arranged as two matching planar surface pairs in two locations, each surface having one mirrored counterpart directly facing it. In FIG. 1-2, and FIG. 4, can be seen the grooved surface of ITEM 3 facing one of the grooved surfaces of ITEM 6, as well as the other grooved surface of ITEM 6 facing the grooved surface of ITEM 7. These four grooved surfaces are the planar surfaces detailed above. Of each paired planar surface one surface (in this case the inner planar surface) is stationary, while the other planar surface rotates with the spindle member of the host mechanism. In FIG. 1-2, FIG. 2, and FIG. 4, ITEM 6 is stationary while ITEM 3 and ITEM 7 rotate. The rotating members from each of the paired planar surfaces rotate as one with the spindle member. Each set of matching planar surfaces is separated by a gap between the planar surfaces. This gap can be seen in FIG. 1-2 between ITEM 3 and ITEM 6 and again between ITEM 6 and ITEM 7. The gap distance between the matching planar surfaces will be governed by the geometry of the spherical rolling members or ball bearings. The distance between the first pair of planar surfaces and the second pair of planar surfaces is non-critical to the functioning of the invention.

Into each of the planar surfaces not less than one groove is generated. The major diameter of this groove as well as the minor diameter must each match the diameters on the mirrored counterpart planar surfaces. The center points of all of these grooves must be on the same line forming an axis. The width of the matching grooves must be less than the diameter of the rolling members or ball bearings such that the diameters of the ball bearings touch the vertices resulting from the intersection of each of the two sides of the grooves with the planar surfaces. These vertices will provide initial contact for the ball bearings of the invention. Line contact on an array of ball bearings is thus produced. FIG. 1-2 shows the line contact of two vertices of ITEM 3 on one side of ITEM 4 as well as two vertices of ITEM 6 on the other side of ITEM 4. ITEM 4 is an array of ball bearings. The same vertices to ball bearing contact exists on the other end of ITEM 6 where it makes contact with a second array of ball bearings while the two vertices of ITEM 7 make contact with the other side of this second array of ball bearings. A total of eight vertices making line contact at four locations on one array of ball bearings as well as at four locations on a second array of ball bearings is thus seen in FIG. 1-2. The distance of the groove from the planar surface is not critical to the proper functioning of the invention provided that no additional contact with the ball bearings results. This distance does affect the longevity of the host device, and so it should be great enough to allow the ball bearings to form the malleable grooved member without coming into contact with the bottom of the groove.

Further, the invention contains two arrays of ball bearings, each array filling the distance between the two vertices of one of the planar surfaces and the two vertices of its mirrored counterpart. The identical result happens at the location of the other pair of planar surfaces. The result is two arrays of ball bearings, each ball in the arrays making line contact in four places. The diameters of the vertices must match and also be concentric with the vertices on the mirrored counterparts. The number of ball bearings must be sufficient to fill the orbit produced by the vertices of the major and minor diameters of the groove or grooves generated into the malleable member of the planar surface.

The ball bearings should be fabricated from material sufficiently dense and sufficiently hard to favorably withstand and transfer the functional pressure applied to them. The pressure must be great enough to exceed the compressive strength of the malleable race material at the point of contact where the ball bearings meet the grooved malleable member. The ball bearings should match one another in size to the desired accuracy of the host mechanism in which this invention is used. The invention will exploit fully the degree of accuracy of the ball bearings. If each of the diameters of the ball bearings is within 0.000025 inches of all of the other ball bearings of an array, the overall concentricity and axial trueness of the host device will also be within 0.000025 inches.

A retainer can be used to keep the ball bearings from bunching and rubbing against each other. FIG. 2 shows two retainers, ITEM 5, shown out of position so that these can be viewed fully. FIG. 1-2 and FIG. 4, show the same item in assembly. The function of ITEM 5 is to prevent the highly precise individual ball bearings from rubbing against one another which would cause their accuracy to deteriorate quickly. The fabrication material for ITEM 5 can be any material that is less hard than the ball bearings.

Further, the invention provides for the progressive contracting/compressing of the four parallel planes of malleable material toward one another so that the ball bearings gradually enter deeper into the groove or grooves that have been generated into the planar surfaces. This is accomplished while keeping the four planar surfaces parallel, drawing them together along the axis defined by the rotation of the planar surfaces, which is coincident with the center points of the vertices with which the ball bearings are making line contact. Referring to FIG. 1-2, and FIG. 4, ITEM 6 remains immobile while ITEM 3 and ITEM 7 are gradually drawn closer to ITEM 6. A fine threaded custom nut provides the motivating movement that reduces the gaps between the four planar surfaces along the axis of the spindle, said axis being coincident with the center points of the eight round edges formed by the groove vertices on the four planar surfaces. Any method that maintains the parallelism of the planar surfaces while reducing the gaps between them is acceptable. A method requiring regular adjustment is acceptable.

Further, a crank arm fixed to the custom nut supplies constant rotational tension, with the end result being that the two arrays of ball bearings have a constant forming pressure applied to them. This forming pressure must progress unidirectionally along the axis. Any other system chosen to draw the 4 planar surfaces together while keeping them parallel, must also secure the same unidirectional tension. This is not a ball bearing assembly with a spring preload, it is a ball bearing assembly in the constantly active state of forming its races around the ball bearings. The rotational pressure of the crank arm is supplied by a band spring as shown in FIG. 2 and FIG. 4, ITEM 11 located in the body of the crank arm and this spring is under constant tension against an anchor ring as shown in FIG. 1-2, FIG. 2, and FIG. 4, ITEM 10 attached to the end of the spindle shank, thus providing constant rotational pressure to the custom nut through the crank arm.

The invention is dynamic in its operation. The changes that must occur with use in every bearing device with rolling components are used to improve this invention so that the bearing is constantly wearing in to a state of theoretically perfect roundness and ever greater durability.

Upon initial assembly and subsequent use, the ball bearings will always tend toward the path of least resistance. The path of least resistance for the aforesaid ball bearings under pressure is, theoretically, a perfectly round path or a perfect circle. Any other path will produce a change in radius distance either along the circumference or along the axis. Such a change in distance will produce an increased resistance to the desired rotational movement of the device, and therefore the device will always tend toward perfectly round rotation and perfect axial non-variance.

The invention upon initial assembly will readily rotate but the contact area on each of the ball bearings is small and fragile. The invention requires a period of use in order to wear in to a more durable state.

FIG. 5-1 and FIG. 5-2, exist to give clarity to FIG. 5-3.

FIG. 5-1 is an example of an assembled host device showing a section line.

FIG. 5-2 is a section view of this same host device along the section line of FIG. 5-1. FIG. 5-2 has a circle drawn unto it which defines the borders of the enlarged detail view, FIG. 5-3.

FIG. 5-3 shows a greatly enlarged detail view of one of the ball bearings in the array of ball bearings where these ball bearings have formed the malleable material of ITEM 6 and ITEM 3 only slightly. The locations of the formed areas are noted with the letter “A”.

FIG. 6-1 and FIG. 6-2, exist to give clarity to FIG. 6-3.

FIG. 6-1 is an example of an assembled host device showing a section line.

FIG. 6-2 is a section view of this same host device along the section line of FIG. 6-1. FIG. 6-2 has a circle drawn unto it which defines the borders of the enlarged detail view, FIG. 6-3.

FIG. 6-3 shows a greatly enlarged detail view of one of the ball bearings in the array of ball bearings where these ball bearings have formed the malleable material of ITEM 6 and ITEM 3 moderately. The locations of the formed areas are noted with the letter “B”.

FIG. 7-1 and FIG. 7-2, exist to give clarity to FIG. 7-3.

FIG. 7-1 is an example of an assembled host device showing a section line.

FIG. 7-2 is a section view of this same host device along the section line of FIG. 7-1. FIG. 7-2 has a circle drawn unto it which defines the borders of the enlarged detail view, FIG. 7-3.

FIG. 7-3 shows a greatly enlarged detail view of one of the ball bearings in the array of ball bearings where these ball bearings have formed the malleable material of ITEM 6 and ITEM 3 fully. The locations of the formed areas are noted with the letter “C”.

The invention is ready for constant use when the rate of distance change in real time, lessens to a fraction of what it was initially. This change will coincide with a noticeable increase in contact area. Although the rate of distance change in real time lessens, it never totally ceases.

I claim:

1) A long-life ball bearing device that tends towards theoretically perfect concentricity throughout its useful life without any deterioration in precision of performance.

2) A long-life ball bearing device that exploits the full potential of accuracy of the rolling members.

3) A long-life ball bearing device that becomes more durable with use.

4) A ball bearing device whose races conform to the geometry of the ball bearings while simultaneously producing theoretically perfect concentricity of rotation.

5) A device as in claim 4 that initiates with line contact at four points of contact on each and every ball bearing and progressively forms increasingly larger arc-shaped race contract areas.
